(19) United States
(12) Patent Application Publication
(10) Pub. No.: US 2026/0094327 A1
(43) Pub. Date: Apr. 2, 2026

(54) RETRIEVAL AUGMENTED TEXT-TO-IMAGE GENERATION

(71) Applicant: Google LLC, Mountain View, CA (US)

(72) Inventors: William W. Cohen, Pittsburgh, PA (US); Chitwan Saharia, Toronto (CA); Hexiang Hu, Redmond, WA (US); Wenhu Chen, Waterloo (CA)

(21) Appl. No.: 19/115,655

(22) PCT Filed: Sep. 25, 2023
(86) PCT No.: PCT/US2023/033622

§ 371 Date: Mar. 26, 2025

Related U.S. Application Data
(60) Provisional application No. 63/410,414, filed on Sep. 27, 2022.

(51) Int. Cl. G06T 11/60; G06N 3/0455; G06N 3/08; G06T 5/60; G06T 5/70

(52) U.S. Cl. CPC G06T 11/60; G06N 3/0455; G06N 3/08; G06T 5/60; G06T 5/70; G06T 2207/20081; G06T 2207/20084

(57) ABSTRACT

Methods, systems, and apparatus, including computer programs encoded on computer storage media, for generating an output image using a text-to-image model and conditioned on both the input text and image and text pairs selected from a multi-modal knowledge base. In one aspect, a method includes, at each of multiple time steps: generating a first feature map for the time step; selecting one or more neighbor image and text pairs based on their similarities to the input text; for each of the one or more neighbor images and text pairs, generating a second feature map for the neighbor image and text pair; applying an attention mechanism over the one or more second feature maps to generate an attended feature map; and generating an updated intermediate representation of the output image for the time step.

### CROSS-REFERENCE TO RELATED APPLICATION

This application claims priority to U.S. Provisional Application No. 63/410,414, filed on Sep. 27, 2022. The disclosure of the prior application is considered part of and is incorporated by reference in the disclosure of this application.

### BACKGROUND

This specification relates to processing images using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system implemented as computer programs on one or more computers in one or more locations that generates an output image from an input. For example, the input may include input text submitted by a user of the system specifying a particular class of objects or a particular object, and the system can generate the output image conditioned on that input text, i.e., generate the output image that shows an object belonging to the particular class or the particular object.

Particular embodiments of the subject matter described in this specification can be implemented so as to realize one or more of the following advantages. A neural network system as described in this specification can generate images from input text with higher fidelity and faithfulness. In particular, by augmenting the conditional generative process performed by using a text-to-image diffusion model with an information retrieval process which retrieves relevant information from a multi-modal knowledge base of text and image pairs, the performance of the text-to-image diffusion model can be improved, i.e., the accuracy of the visual appearance of the objects that appear in the output images generated by the model can be increased.

By generating the output image using a conditional generative process augmented with information of high-level semantics and low-level visual details of images in relevant text and image pairs selected from the multi-modal knowledge base, the neural network system can generate output images with better real-world faithfulness across a diverse range of objects, even including objects (or object classes) that are rarely seen or completely unseen by the model during training.

When generating video frames, the neural network system as described in this specification can generate more consistent contents by predicting the next video frame in a video, conditioned on a text input and by using information retrieved from the already generated video frames. The use of the retrieval augmented generative process allows the system to generate video frames depicting highly realistic objects in a consistent manner for many frames into the future, i.e., by continuing to append frames generated by the system to the end of temporal sequences to generate more frames.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example image generation system flow.

FIG. 2 is a flow diagram of an example process for updating an intermediate representation of the output image.

FIG. 3 is an example illustration of updating an intermediate representation of the output image.

Like reference numbers and designations in the various drawings indicate like elements.

### DETAILED DESCRIPTION

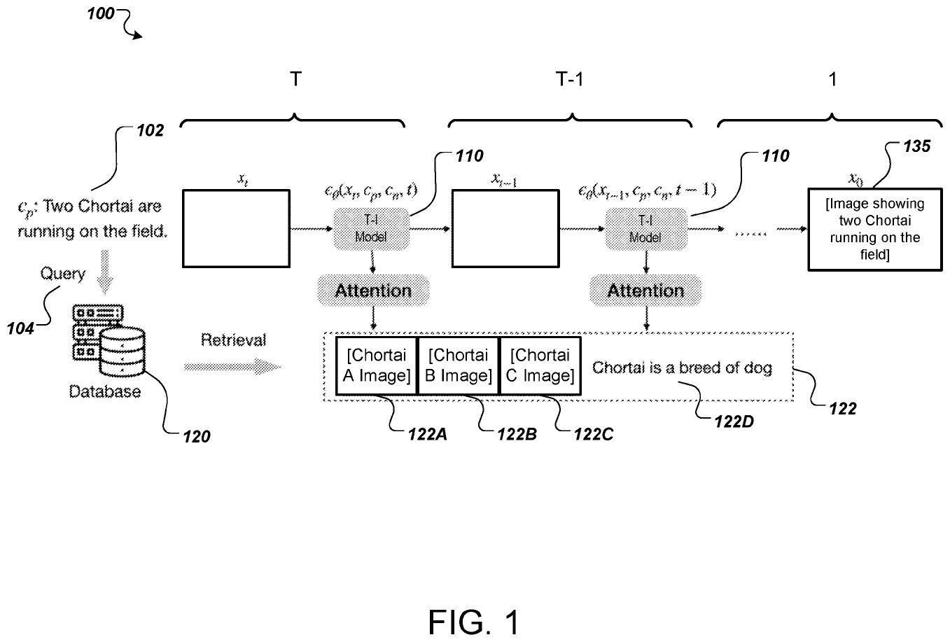

FIG. 1 is a block diagram of an example image generation system 100 flow. The image generation system 100 is an example of a system implemented as computer programs on one or more computers in one or more locations that generates an output image 135 conditioned on input text 102.

Generally, the input text 102 characterizes one or more desired visual properties for the output image 135, i.e., characterizes one or more visual properties that the output image 135 generated by the system should have.

For example, the input text 102 includes text that specifies a particular object that should appear in the output image 102. As another example, the input text 102 includes text that specifies a particular class of objects from a plurality of object classes to which an object depicted in the output image 135 should belong. As yet another example, the input text 102 includes text that specifies the output image 135 should be a next frame that is a prediction of the next video frame in a sequence of video frames already known to the image generation system 100. The known sequence of video frames depicts an object, e.g., having a particular motion.

To generate the output image 135 conditioned on the input text 102, the image generation system 100 includes a text-to-image model 110 and a database comprising a multi-modal knowledge base 120. The image generation system 100 uses the text-to-image model 110 and the multi-modal knowledge base 120 to perform retrieval-augmented, conditional image generation by generating the intensity values of the pixels of the output image 135.

The text-to-image model 110 is used to generate the output image 135 across multiple time steps (referred to as “reverse diffusion time steps”) T, T−1, . . . , 1 by performing a reverse diffusion process.

The text-to-image model 110 can have any appropriate diffusion model neural network (or “diffusion model” for short) architecture that allows the text-to-image model to map a diffusion input that has the same dimensionality as the output image 135 over the reverse diffusion process to a diffusion output that also has the same dimensionality as the output image 135.

For example, the text-to-image model 110 can be a convolutional neural network, e.g., a U-Net or other architecture, that maps one input of a given dimensionality to an output of the same dimensionality.

The text-to-image model 110 has been trained, e.g., by the image generation system 100 or another training system, to, at any given time step, process a model input for the time step that includes an intermediate representation of the output image (as of the time step) to generate a model output for the time step. The model output includes or otherwise specifies a noise term that is an estimate of the noise that needs to be added to the output image 135 being generated by the system 100, to generate the intermediate representation.

For example, the text-to-image model 110 can be trained on a set of training text and image pairs using one of the loss functions described in Jonathan Ho, et al. Denoising Diffusion Probabilistic Models. arXiv:2006.11239, 2020, Chitwan Saharia, et al. Photorealistic text-to-image diffusion models with deep language understanding. arXiv preprint arXiv:2205.11487, 2022, and Aditya Ramesh, et al. Hierarchical textconditional image generation with clip latents. arXiv preprint arXiv:2204.06125, 2022, to generate the model output. Other appropriate training methods can also be used.

The multi-modal knowledge base 120 includes one or more datasets. Each dataset includes multiple pairs of image and text. Generally, for each pair of image and text, the image depicts an object and the text defines, describes, characterizes, or otherwise relates to the object depicted in the image.

For example, the multi-modal knowledge base 120 can include a single dataset that includes images of different classes of objects and their associated text description. The different classes of objects can, for example, include one or more of: landmarks, landscape or location features, vehicles, or tools, food, clothing, animals, or human.

As another example, the multi-modal knowledge base 120 can include multiple, separate datasets arranged according to object classes. For example, the multi-modal knowledge base 120 can include a first dataset that corresponds to a first object class (or, one or more first object classes), a second dataset that corresponds to a second object class (or, one or more second object classes), and so on.

In this example, the first dataset stores multiple pairs of image and text, where each image shows an object belonging to the first object class (or, one of the one or more first object classes) corresponding to the dataset. Likewise, the second dataset stores multiple pairs of image and text, where each image shows an object belonging to one of the second object class (or, one of the one or more second object classes) corresponding to the dataset.

As yet another example, the multi-modal knowledge base 120 can include a dataset that stores a sequence of video frames of one or more objects and corresponding text description of the video frames. That is, for each image and text pair stored in the dataset, the image is a video frame, and the text is a caption for the video frame.

In some implementations, the datasets in the multi-modal knowledge base 120 are local datasets that are already maintained by the image generation system 100. For example, the image generation system 100 can receive one of the local datasets as an upload from a user of the system.

In some other implementations, the datasets in the multi-modal knowledge base 120 are remote datasets that are maintained at another server system that is accessible by the image generation system 100, e.g., through an application programming interface (API) or another data interface.

In yet other implementations, some of the datasets in the multi-modal knowledge base are local datasets, while others of the datasets are remote datasets.

The local or remote datasets in these implementations can have any size. For example, some remote datasets accessible by the image generation system 100 can be large-scale, e.g., Web-scale, datasets that include hundreds of millions or more of image and text pairs. For example, a remote system identifies the different images by crawling electronic resources, such as, for example, web pages, electronic files, or other resources that are available on a network, e.g., the Internet. The images are labeled, and the labeled images are stored in the format of image and text pairs in one of the remote datasets.

Given the variety, breadth, or both of the very large number of image and text pairs stored therein, the multi-modal knowledge base 120 thus represents external knowledge, i.e., knowledge that is external to the text-to-image model 110, that may not have been used in the training of the text-to-image model 110.

The provision of the multi-modal knowledge base 120 allows for the image generation system 100 to augment the process of generating the output image 135 conditioned on the input text 102 with information retrieved from the multi-modal knowledge base 120.

In this way, the image generation system described in this specification generates images with improved real-world faithfulness (e.g. improved accuracy), as measured by for example the Fréchet inception distance (FID) score, compared to other systems which do not use the described techniques. In particular, the image generation system uses the relevant information included in the neighbor image and text pairs 122 to boost the performance of the text-to-image model 110 to generate output images 135 with better real-world faithfulness across a diverse range of objects, even including objects (or object classes) that are rarely seen or completely unseen by the model during training.

To that end, at each of one or more of the multiple reverse diffusion time steps over the reverse diffusion process, the image generation system 100 selects one or more neighbor image and text pairs 122 based on their similarities to the input text 102, and subsequently applies an attention mechanism to generate an attended feature map, which is then processed by the text-to-image model 110 to generate an updated intermediate representation of the output image 135 for the reverse diffusion time step.

That is, the image generation system 100 uses the model output generated by the text-to-image model 110 and one or more neighbor image and text pairs 122 to update the intermediate representation of the output image 135 as of the time step.

Generally, to apply the attention mechanism, the image generation system 100 uses one or more attention heads, which can be implemented as one or more neural networks. Each attention head generates a set of queries, a set of keys, and a set of values, and then applies any of a variety of variants of query-key-value (QKV) attention, e.g., a dot product attention function or a scaled dot product attention function, using the queries, keys, and values to generate an output. Each query, key, value can be a vector that includes one or more vector elements.

For example, the attention mechanism in FIG. 1 can be a cross-attention mechanism. In cross-attention, the queries are generated from a feature map that have been generated based on the intermediate representation of the output image for the reverse diffusion time step, while the keys and values are generated from a feature map that have been generated based on the one or more neighbor image and text pairs 122 selected for the reverse diffusion time step.

As used herein, the neighbor image and text pairs 122 are image and text pairs that are selected based on (i) text-to-text similarity between the text in the pairs and the input text 102, (ii) text-to-image similarity between the images in the pairs and the input text 102, or both (i) and (ii).

For example, the text-to-text similarity can be a TF/IDF similarity or a BM25 similarity, while the text-to-image similarity can be a similarity, e.g., CLIP similarity, computed based on a distance between respective embeddings of the images in the pairs and the input text in a co-embedding space that include both text and image embeddings.

As illustrated in FIG. 1, the image generation system 100 receives an input text 102 which includes the following text: “Two Chortai are running on the field.” Accordingly, at a given reverse diffusion time step T−1, the image generation system 100 selects, from the multi-modal knowledge base 120, multiple neighbor image and text pairs 122. Because “Chortai” is mentioned in the input text 102, each neighbor pair 122 selected by the system includes an image of a Chortai, e.g., Chortai image A 122A, Chortai image B 122B, or Chortai image C 122C, and the text 122D of “Chortai is a breed of dog.”

In some implementations, the image generation system 100 uses text-to-image similarity to select the neighbor image and text pairs 122. Specifically, the system selects neighbor images from the multi-modal knowledge base 120 based on text-to-image similarities, and in turn, uses the image and text pairs from the multi-modal knowledge base 120 which includes the selected neighbor images as the neighbor image and text pairs 122.

In general, any number of neighbor images that satisfy a text-to-image similarity threshold can be selected. For example, the image generation system 100 can select, as the neighbor images, one or more images from (the one or more datasets within) the multi-modal knowledge base 120 that have the highest text-to-image similarities relative to the input text 102 among the text-to-image similarities of all images stored in the multi-modal knowledge base 120.

As another example, the image generation system 100 can select, as the neighbor images, one or more images from (the one or more datasets within) the multi-modal knowledge base 120 that each have a text-to-image similarity relative to the input text 102 that is greater than a given value.

In some other implementations, the image generation system 100 uses text-to-text similarity to select the neighbor image and text pairs 122. Specifically, the system selects neighbor text from the multi-modal knowledge base 120 based on text-to-text similarities, and in turn, uses the image and text pairs from the multi-modal knowledge base 120 which includes the selected neighbor text as the neighbor image and text pairs 122.

Analogously, any number of neighbor text that satisfy a text-to-text similarity threshold can be selected. For example, the image generation system 100 can select, as the neighbor text, one or more text from (the one or more datasets within) the multi-modal knowledge base 120 that have the highest text-to-text similarities relative to the input text 102 among the text-to-text similarities of all text stored in the multi-modal knowledge base 120.

As another example, the image generation system 100 can select, as the neighbor text, one or more text from (the one or more datasets within) the multi-modal knowledge base 120 that each have a text-to-text similarity relative to the input text 102 that is greater than a given value.

In yet other implementations, the image generation system 100 uses both text-to-image similarity and text-to-text similarity to select the neighbor image and text pairs 122. Specifically, for each image of text pair stored in the multi-modal knowledge base 120, the system can combine, e.g., by computing a sum or product of, (i) the text-to-image similarity of the image included in the pair relative to the input text 102 and (ii) the text-to-text similarity of the text included in the pair relative to the input text 102, to generate a combined similarity for the pair, and then select one or more neighbor images and text pairs 122 that satisfy a combined similarity threshold.

In the example of FIG. 1, a total of three neighbor image and text pairs 122 are selected at the given step. It will be appreciated that, in other examples, more or fewer pairs can be selected. In some cases, the image generation system 100 selects the same, fixed number of neighbor image and text pairs 122 at different reverse diffusion time steps, while in other cases, the image generation system 100 selects varying numbers of neighbor image and text pairs 122 across different reverse diffusion time steps.

Moreover, in some cases, the same text (e.g., the text of “Chortai is a breed of dog” in the example of FIG. 1) is included all of the three neighbor image and text pairs 122; thus different neighbor pairs include different images but the same text. In other cases, however, different text may be included in the three neighbor image and text pairs 122; thus different neighbor pairs include different images and also different text.

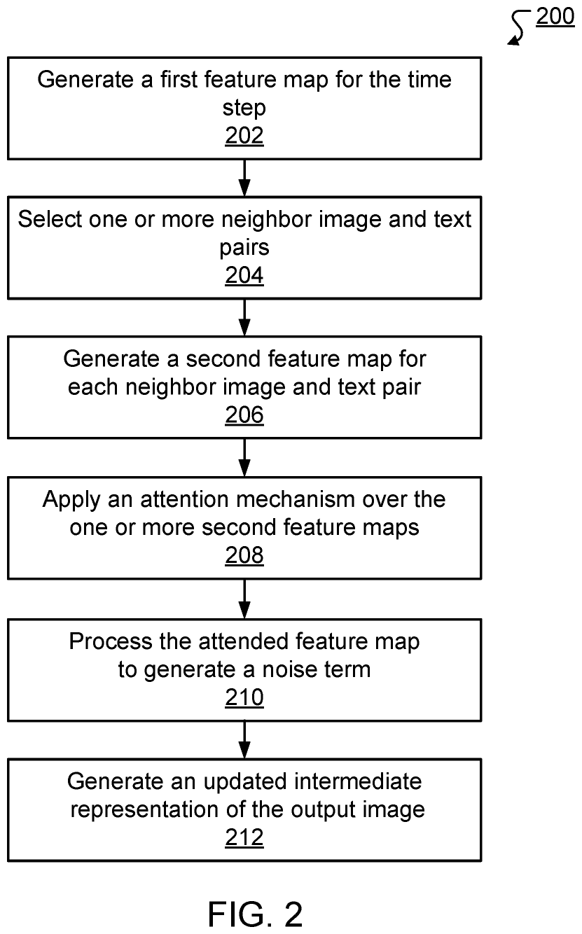

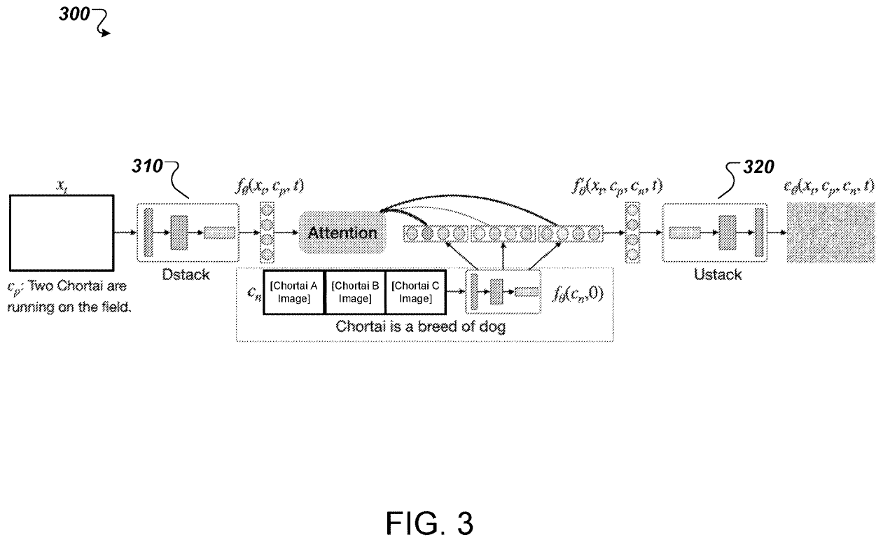

Performing retrieval-augmented reverse diffusion process is described in more detail below with reference to FIGS. 2-3.

After the last reverse diffusion time step in the process, the image generation system 100 outputs the updated intermediate representation as the final output image 135. In other words, the final output image 135 is the updated intermediate representation generated in the last step of the multiple reverse diffusion time steps.

Because the reverse diffusion process was augmented by information (e.g., high-level semantics information, low-level visual detail information, or both) included in the neighbor image and text pairs 122 retrieved from the multi-modal knowledge base 120, the final output image 135 will have improved accuracy in the visual appearances of the objects specified in the input text 102.

For example, the image generation system 100 can provide the output image 135 for presentation to a user on a user computer, e.g., as a response to the user who submitted the input text 102. As another example, the image generation system 100 can store the output image 135 for later use.

FIG. 2 is a flow diagram of an example process 200 for updating an intermediate representation of the output image by using a text-to-image model and a multi-modal knowledge base. For convenience, the process 200 will be described as being performed by a system of one or more computers located in one or more locations. For example, a data generation system, e.g., the system used in the data generation system 100 flow depicted in FIG. 1, appropriately programmed in accordance with this specification, can perform the process 200.

The example process 200 is described with reference to FIG. 3, which is an example illustration 300 of updating an intermediate representation of the output image.

The system can perform multiple iterations of the process 200 to generate an output image in response to receiving input text. For example, when the input text includes text that specifies or describes a particular object, the output image will depict the particular object. As another example, when the input text includes text that specifies or describes a particular class of objects from a plurality of object classes, the output image will depict an object that belongs to the particular class. As yet another example, when the input text includes text that specifies the output image should be a next frame that is a prediction of the next video frame in a sequence of video frames already known to the system, the output image will be a frame that shows the same object that has been depicted in the sequence of video frames, e.g., having a continued motion.

Prior to the first iteration of the process 200, the system initializes a representation of the output image. The initial representation of the output image is the same dimensionality as the final output image but has noisy values.

For example, the system can initialize the output image, i.e., can generate the initial representation of the output image, by sampling each of one or more intensity values for each pixel in the output image from a corresponding noise distribution, e.g., a Gaussian distribution, or a different noise distribution. That is, the output image includes multiple intensity values and the initial representation of the output image includes the same number of intensity values, with each intensity value being sampled from a corresponding noise distribution.

The system then generates the final output image by repeatedly, i.e., at each of multiple time steps, performing an iteration of the process 200 to update an intermediate representation of the output image. In other words, the final output image is the updated intermediate representation generated in the last iteration of the process 200. In some situations, the multiple iterations of the process 200 can be collectively referred to as a reverse diffusion process, with one iteration of the process 200 being performed at each reverse diffusion time step during the reverse diffusion process.

The system processes a model input that includes (i) an intermediate representation xₜ of the output image for the time step, (ii) the input text cₚ (or data derived from the input text cₚ, e.g., an embedding of the input text generated by a text encoder neural network from processing the input text), and (iii) time step data/defining the time step using a text-to-image model to generate a first feature map for the time step (step 202). For the very first time step, the intermediate representation xₜ is the initial representation. For any subsequent time step, the intermediate representation xₜ is the updated intermediate representation that has been generated in the immediately preceding time step.

In the example of FIG. 3, the text-to-image model has a U-Net architecture, which includes an encoder 310 (a downsampling encoder or “DStack”) and a decoder 320 (an upsampling decoder or “UStack”). As illustrated, the encoder 310 of the text-to-image model processes the model input to generate the first feature map that is defined by:

$${f}_{θ} ( {x}_{t} , {c}_{p} , t ) ∈ {ℝ}^{F \times F \times d} ,$$

where F represents the feature map width, d represents the hidden dimension, and θ represents the parameters of the text-to-image model.

The system selects one or more neighbor image and text pairs from the multi-modal knowledge base based on their similarities to the input text (step 204). Selecting the one or more neighbor images and text pairs from the multi-modal knowledge base may comprise querying the multi-modal knowledge base. The input text may be used as the query. To perform this selection, the system determines, for each image and text pair stored in the multi-modal knowledge, a corresponding similarity of the image and text pair to the input text based on (i) a text-to-text similarity between the input text and the text in the image and text pair, (ii) a text-to-image similarity between the input text and the image in the image and text pair, or both (i) and (ii).

For example, the text-to-text similarity can be a TF/IDF similarity or a BM25 similarity, and the text-to-image similarity can be a CLIP similarity or a different similarity computed based on distances in an embedding space.

When a large number of, e.g., one million, ten million, one billion, or more, image and text pairs are stored in the multi-modal knowledge base, however, computation of their similarities to the input text is slow and processor resource intensive. Some implementations of the system thus use an approximate nearest neighbor matching technique, i.e., instead of a brute-force method, to enable faster computation time while retaining a high level of accuracy.

For example, the system can use search space pruning, search space quantization, or both. As a particular example of quantization technique, the system can use an anisotropic quantization-based MIPS technique descried in more detail at Ruiqi Guo, et al. Accelerating large-scale inference with anisotropic vector quantization. In International Conference on Machine Learning, pp. 3887-3896. PMLR, 2020.

For each of the one or more neighbor images and text pairs, the system processes (i) the image in the neighbor image and text pair and (ii) the text in the neighbor image and text pair (or data derived from the text, e.g., an embedding of the text generated by a text encoder neural network from processing the text) using the text-to-image model to generate a second feature map for the neighbor image and text pair (step 206). In various implementations, the image in the neighbor image and text pair comprises pixels. Processing the image in the neighbor image and text pair may comprise processing the pixels.

In the example of FIG. 3, the encoder 310 of the text-to-image model, which generated the first feature map at step 202, also processes the neighbor images and text pairs to generate one or more second feature maps that is defined by:

$${f}_{θ} ( {c}_{n} , 0 ) ∈ {R}^{K \times F \times F \times d} ,$$

Where cₙ represents neighbor images and text pairs, e.g., cₙ:=[<image, text>₁; . . . , <image, text>_{K}], which represents the K neighbor images and text pairs (where K is an integer greater than or equal to one), and the time step data is set to null (t=0).

It will be appreciated that, in other examples, a different component of the system, e.g,. one or more other encoder neural networks, are used to process the neighbor images and text pairs to generate the second feature map.

The system applies an attention mechanism over the one or more second feature maps using one or more queries derived from the first feature map for the time step to generate an attended feature map (step 208). That is, the system generates an attended feature map that is defined by:

$${f}_{θ}^{′} ( {x}_{t} , {c}_{p} , {c}_{n} , t ) = Attn ( {f}_{θ} ( {x}_{t} , {c}_{p} , t ) , {f}_{θ} ( {c}_{n} , 0 ) ) ,$$

θ represents the parameters of the text-to-image model.

For example, the attention mechanism can be a cross-attention mechanism. In cross-attention, the system uses the first feature map to generate one or more queries, e.g., by applying a query linear transformation to the first feature map. The system also uses the one or more second feature maps to generate one or more keys and one or more and values, e.g., by applying a key or a value linear transformation to the one or more second feature maps. Next, the system applies any of a variety of variants of query-key-value (QKV) attention, e.g., a dot product attention function or a scaled dot product attention function, using the one or more queries, the one or more keys, and the one or more values to generate the attended feature map as an output of the attention mechanism.

The system processes the attended feature map for the time step using the text-to-image model to generate a noise term ϵ for the time step (step 210). In the example of FIG. 3, the decoder 320 of the text-to-image model generate a noise term ϵ that is defined by:

$${ϵ}_{θ} ( {x}_{t} , {c}_{p} , {c}_{n} , t ) ,$$

where θ represents the parameters of the text-to-image model, cₚ represents the input text, and cₙ represents the neighbor image and text pairs.

In some implementations, the system makes use of a guidance when generating the noise term ϵ. For example, the system can use classifier-free guidance that follows an interleaved guidance schedule which alternates between input text guidance and neighbor retrieval guidance to improve both text alignment and object alignment. In this example, the noise term ϵ can be computed by:

$${\hat{ϵ}}_{p} = {w}_{p} \cdot {ϵ}_{θ} ( {x}_{t} , {c}_{p} , {c}_{n} , t ) − ( {w}_{p} − 1 ) \cdot {ϵ}_{θ} ( {x}_{t} , {c}_{n} , t )$$

$${\hat{ϵ}}_{n} = {w}_{n} \cdot {ϵ}_{θ} ( {x}_{t} , {c}_{p} , {c}_{n} , t ) − ( {w}_{n} − 1 ) \cdot {ϵ}_{θ} ( {x}_{t} , {c}_{p} , t ) ,$$

where \hat{ϵ}ₚ and \hat{ϵ}ₙ are the text-enhanced noise term prediction and neighbor-enhanced noise term prediction, respectively; ωₚ is the input text guidance weight, and ωₙ is the neighbor retrieval guidance weight. The two guidance predictions are interleaved by a predefined ratio η. At each guidance step, a number R is randomly sampled from [0, 1], and if R<η, \hat{ϵ}ₚ is computed, otherwise \hat{ϵ}ₙ is computed. The predefined ratio η can be a tunable parameter of the system that balances the faithfulness with respect to input text or the neighbor image and text pairs.

The system generates an updated intermediate representation xₜ₋₁ of the output image for the time step based on using the noise term ϵ to update the intermediate representation xₜ of the output image (step 212).

For example, the updated intermediate representation xₜ₋₁ can be computed by using the noise term ϵ to de-noise the intermediate representation xₜ as follows:

$${x}_{t - 1} = \frac{\sqrt{{\overline{α}}_{t - 1}} {β}_{t}}{1 − {\overline{α}}_{t}} {\hat{x}}_{θ} ( {x}_{t} , c ) + \frac{\sqrt{{α}_{t}} ( 1 − {\overline{α}}_{t - 1} )}{1 − {\overline{α}}_{t}} {x}_{t} + \frac{\sqrt{( 1 − {\overline{α}}_{t - 1} ) {β}_{t}}}{\sqrt{1 − {\overline{α}}_{t}}} ϵ ,$$

$$where$$

$${\hat{x}}_{θ} ( {x}_{t} , c ) := ( {x}_{t} - \sqrt{1 - {\hat{a}}_{t}} {ϵ}_{θ} ( {x}_{t} , c , t ) ) / \sqrt{{\hat{a}}_{t}} ,$$

$$and$$

$${α}_{t} := 1 - {β}_{t} and {\overline{α}}_{t} := {\prod }_{s = 1}^{t} {α}_{s} ,$$

βt defines the variance for the time step according to a predetermined variance schedule β1, β2, . . . , β_{T-1}, β_{T}, and c is the conditioning input that includes both the input text cₚ and the neighbor images and text pairs cₙ.

By repeatedly performing the process 200, the system can update an intermediate representation of the output image to generate the final output image. That is, the process 200 can be performed as part of predicting an output image from input text for which the desired output, i.e., the output image that should be generated by the system from the input text, is not known.

Some or all steps of the process 200, e.g., steps 202-210, can also be performed as part of processing training inputs derived from a training dataset, i.e., inputs derived from a set of input text and/or images for which the output images that should be generated by the system is known, in order to fine-tune a pre-trained text-to-image model to determine fine-tuned values for the parameters of the model, i.e., from their pre-trained values.

Specifically, the system can repeatedly perform steps 202-210 on training inputs selected from an image and text dataset as part of a diffusion model training process to fine-tune the text-to-image model to optimize a fine-tuning objective function that is appropriate for the retrieval-augmented conditional image generation task that the text-to-image model is configured to perform.

For example, the fine-tuning objective function can include a time re-weighted square error loss term that trains the text-to-image model θ on images x₀ selected from a set of images to minimize a squared error loss between each image x₀ and an estimate of the image \hat{x}₀ generated by the text-to-image model as of a sampled reverse diffusion time step t within the reverse diffusion process:

$${𝔼}_{{x}_{0} , ϵ , t} [ {w}_{t} \cdot {‖ {\hat{x}}_{θ} ( {x}_{t} , c ) − {x}_{0} ‖}_{2}^{2} ] ,$$

$$where$$

$${\hat{x}}_{θ} ( {x}_{t} , c ) := ( {x}_{t} − \sqrt{1 − {\overline{α}}_{t}} {ϵ}_{θ} ( {x}_{t} , c , t ) ) / \sqrt{{\overline{α}}_{t}} ,$$

and c is the conditioning input, xₜ:=\sqrt{α̅ₜ}x₀+\sqrt{1−α̅ₜ}ϵ represents the noisy image as of the time step t with the noise term

$$ϵ ∼ 𝒩 ( 0 , I ) , {α}_{t} := 1 − {β}_{t} and {\overline{α}}_{t} := {\prod }_{s = 1}^{t} {α}_{s} .$$

During training, the system can incorporate any number of techniques to improve the speed, the effectiveness, or both of the training process. For example, during the training, the text-to-image diffusion model can be configured to make unconditional noise predictions ϵ_{θ}(xₜ, t) by randomly dropping out the input text, i.e., by setting cₚ and/or cₙ to null.

As another example, some implementations of the text-to-image model can include a sequence (or “cascade”) of a low resolution diffusion model and a high resolution diffusion model, which is configured to generate a high resolution image as the output image conditioned on a low resolution image generated by the lower resolution diffusion model. By making use of a sequence of diffusion models that can each be conditioned on the text input, the system can iteratively up-scale the resolution of the image, ensuring that a high-resolution image can be generated without requiring a single model to generate the image at the desired output resolution directly. In these implementations, the system can train the low resolution diffusion model and the high resolution diffusion model on different training inputs.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a JAX framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method comprising:
receiving input text;
generating, by using a text-to-image model and conditioned on both the input text and image and text pairs selected from a multi-modal knowledge base, an output image, wherein the generating comprises, at each of multiple time steps:
processing (i) an intermediate representation of the output image for the time step and (ii) the input text using an encoder of the text-to-image model to generate a first feature map for the time step;
selecting one or more neighbor image and text pairs from the multi-modal knowledge base based on their similarities to the input text;
for each of the one or more neighbor images and text pairs, processing (i) the image in the neighbor image and text pair and (ii) the text in the neighbor image and text pair using the encoder of the text-to-image model to generate a second feature map for the neighbor image and text pair;
applying an attention mechanism over the one or more second feature maps using one or more queries derived from the first feature map for the time step to generate an attended feature map; and
generating an updated intermediate representation of the output image for the time step based on using a noise term to de-noise the intermediate representation of the output image, comprising processing the attended feature map for the time step using a decoder of the text-to-image model to generate the noise term.

2. The method of claim 1, wherein:
the input text specifies a particular object class; and
the output image depicts an object belonging to the particular object class.

3. The method of claim 1, wherein generate the first feature map for the time step further comprises processing time step data defining the time step using the encoder of the text-to-image model.

4. The method of claim 1, wherein selecting the one or more neighbor image and text pairs from the multi-modal knowledge base based on their similarities to the input text comprises, for each image and text pair:
determining a corresponding similarity of the image and text pair to the input text based on (i) a text-to-text similarity between the input text and the text in the image and text pair, (ii) a text-to-image similarity between the input text and the image in the image and text pair, or both (i) and (ii).

5. The method of claim 4, wherein the text-to-text similarity comprises a BM25 similarity.

6. The method of claim 4, wherein the text-to-image similarity comprises a CLIP similarity.

7. The method of claim 1, wherein selecting the one or more neighbor image and text pairs from the multi-modal knowledge base comprises using search space pruning and quantization techniques.

8. The method of claim 1, wherein applying the attention mechanism over the one or more second feature maps comprises:
using the one or more second feature maps to generate one or more keys; and
applying the attention mechanism over the one or more second feature maps generated from the one or more neighbor image and text pairs using the one or more queries and the one or more keys.

9. The method of claim 1, wherein the text-to-image image is a text-to-image diffusion model and each time step corresponds to a reverse diffusion time step.

10. The method of claim 9, wherein the text-to-image diffusion model comprises a cascade of a low resolution diffusion model and a high resolution diffusion model, the high resolution diffusion model configured to generate a high resolution image as the output image conditioned on a low resolution image generated by the lower resolution diffusion model.

11. The method of claim 9, wherein generating the output image comprises using a classifier-free guidance.

12. The method of claim 9, wherein generating the output image comprises using an interleaved guidance schedule of text-enhanced noise predictions and neighbor-enhanced noise predictions.

13. The method of claim 9, further comprising training the text-to-image diffusion model on an image and text dataset to determine trained values of parameters of the text-to-image diffusion model based on optimizing a time re-weighted square error loss.

14. The method of claim 13, wherein the training comprises training the text-to-image diffusion model to make unconditional noise predictions by randomly dropping out the input text.

15. A system comprising one or more computers and one or more storage devices storing instructions that are operable, when executed by the one or more computers, to cause the one or more computers to perform the operations of the respective method of claim 1.

16. A computer storage medium encoded with instructions that, when executed by one or more computers, cause the one or more computers to perform the operations of the respective method of claim 1.
